(19) United States
(12) Patent Application Publication
(10) Pub. No.: US 2023/0013979 A1
(43) Pub. Date: Jan. 19, 2023

(54) FOLDING KNIFE APPARATUS AND METHOD

(71) Applicant: Dean Hogarth, Brooklyn, NY (US)

(72) Inventor: Dean Hogarth, Brooklyn, NY (US)

(21) Appl. No.: 17/378,283

(22) Filed: Jul. 16, 2021

(51) Int. Cl. B26B 1/04; B26B 1/10

(52) U.S. Cl. CPC B26B 1/046; B26B 1/10

(57) ABSTRACT

A folding knife apparatus including a blade portion; and a handle portion including a flexing plate connected to a base portion; and a piece. The blade portion may be connected to the handle portion so that the blade portion can rotate with respect to the handle portion when the flexing plate is in alignment with the base portion; and wherein the piece is configured to be placed in a state which prevents the flexing plate of the handle portion from moving into alignment with the base portion, and thereby prevents the blade portion from rotating with respect to the handle portion. The piece may have a J-shaped portion, at least a part of which is inserted between the flexing plate and the base portion of the handle portion to prevent the flexing plate of the handle portion from moving into alignment with the base portion of the handle portion.

### FIELD OF THE INVENTION

This invention relates to folding knife apparatuses and method.

### BACKGROUND OF THE INVENTION

There are various folding knives known in the art.

### SUMMARY OF THE INVENTION

In at least one embodiment of the present application, a folding knife apparatus is provided. The folding knife apparatus may include a blade portion; a handle portion including a flexing plate connected to a base portion; and a piece.

The blade portion may be connected to the handle portion so that the blade portion can rotate with respect to the handle portion when the flexing plate is in alignment with the base portion of the handle portion; and wherein the piece is configured to be placed in a state which prevents the flexing plate of the handle portion from moving into alignment with the base portion of the handle portion, and thereby prevents the blade portion from rotating with respect to the handle portion.

In at least one embodiment the piece has a J-shaped portion, at least a part of which is inserted between the flexing plate and the base portion of the handle portion to prevent the flexing plate of the handle portion from moving into alignment with the base portion of the handle portion.

In at least one embodiment the flexing plate has a slot into which the piece is at least partially inserted to prevent the flexing plate of the handle portion from moving into alignment with the base portion of the handle portion.

In at least one embodiment the piece is connected to a protrusion which protrudes out through an opening in the base portion of the handle portion; wherein the protrusion can be moved to cause the piece to be placed in either a state where the piece prevents the flexing plate of the handle portion from moving into alignment with the base portion of the handle portion or a state where the piece does not prevent the flexing plate of the handle portion from moving into alignment with the base portion of the handle portion.

In at least one embodiment of the present invention a method is provided which may include connecting a piece between a base portion of a handle portion of a folding knife apparatus and a blade portion of the folding knife of an apparatus; and connecting the blade portion to the handle portion so that the blade portion can rotate with respect to the handle portion when a flexing plate of the handle portion is in alignment with the base portion of the handle portion; and wherein the piece is configured to be placed in a state which prevents the flexing plate of the handle portion from moving into alignment with the base portion of the handle portion, and thereby prevents the blade portion from rotating with respect to the handle portion.

The folding knife apparatus for use with a method in accordance with the present invention may be constructed as previously described.

### BRIEF DESCRIPTION OF THE DRAWINGS

FIG. 1 shows a top view of a folding knife apparatus in accordance with an embodiment of the present invention, with the folding knife apparatus shown in an open first state,

FIG. 2 shows a top view of the folding knife apparatus of FIG. 1, with the folding knife apparatus of FIG. 1, shown in an open second state;

FIG. 3 shows a bottom view of the folding knife apparatus of FIG. 1, with the folding knife apparatus of FIG. 1, shown in the open first state;

FIG. 4 shows a bottom view of the folding knife apparatus of FIG. 1, with the folding knife apparatus of FIG. 1, shown in the open second state;

FIG. 5 shows a top view of the folding knife apparatus of FIG. 1, with the folding knife apparatus of FIG. 1, shown in a closed third state;

FIG. 6 shows a bottom view of the folding knife apparatus of FIG. 1, with the folding knife apparatus of FIG. 1, shown in the closed third state;

FIG. 7 shows a left side view of the folding knife apparatus of FIG. 1, with the folding knife apparatus of FIG. 1, shown in the open first state;

FIG. 8 shows a right side view of the folding knife apparatus of FIG. 1, with the folding knife apparatus of FIG. 1, shown in the open first state;

FIG. 9 shows a right side view of the folding knife apparatus of FIG. 1, with the folding knife apparatus of FIG. 1, shown in the open second state;

FIG. 10 shows a bottom view of the folding knife apparatus of FIG. 1, with the folding knife apparatus of FIG. 1, shown in the open second state as in FIG. 4, except that FIG. 10, unlike FIG. 4, is a transparent and/or wireframe view, which shows inner components, and shows inner pins but not outer caps or nuts;

FIG. 11 shows a top view of the folding knife apparatus of FIG. 1, with the folding knife apparatus of FIG. 1, shown in a closed third state, as in FIG. 5, except that FIG. 11, unlike FIG. 5, is a transparent and/or wireframe view, which shows inner components, and shows inner pins but not outer caps or nuts;

FIG. 12 shows a blade plate or portion of the folding knife apparatus of FIG. 1;

FIG. 13 shows a handle plate or portion of the folding knife apparatus of FIG. 1;

FIG. 14 shows a connecting plate of the folding knife apparatus of FIG. 1; and

FIG. 15 shows a rotating piece of the folding knife apparatus of FIG. 1.

### DETAILED DESCRIPTION OF THE DRAWINGS

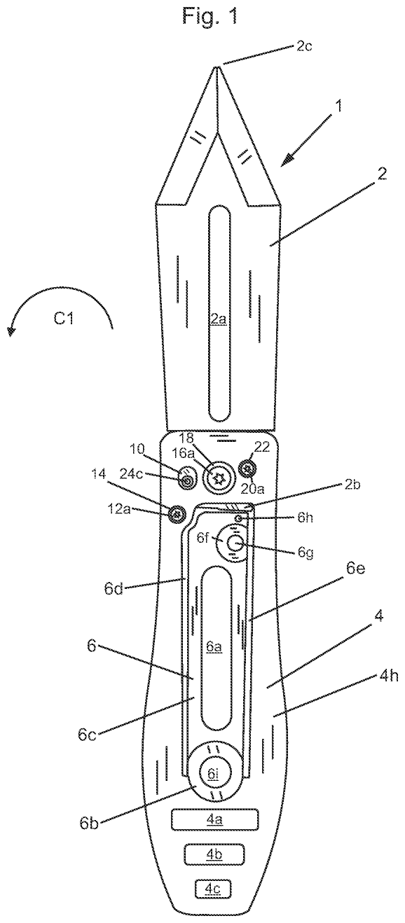

FIG. 1 shows a top view of a folding knife apparatus 1 in accordance with an embodiment of the present invention, with the folding knife apparatus 1 shown in an open first state.

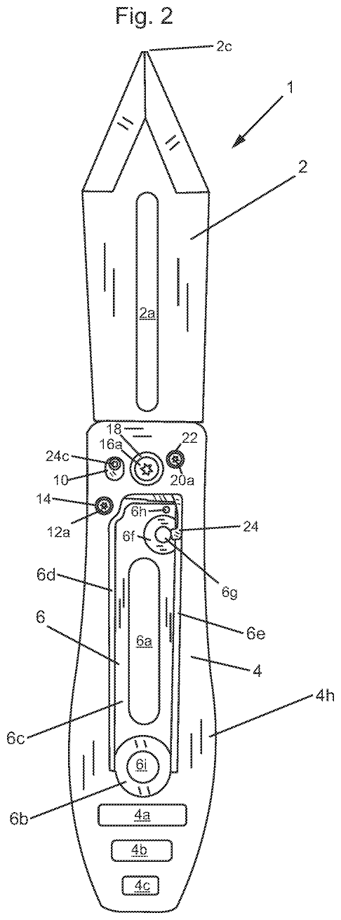

FIG. 2 shows a top view of the folding knife apparatus 1 of FIG. 1, with the folding knife apparatus 1 of FIG. 1, shown in an open second state.

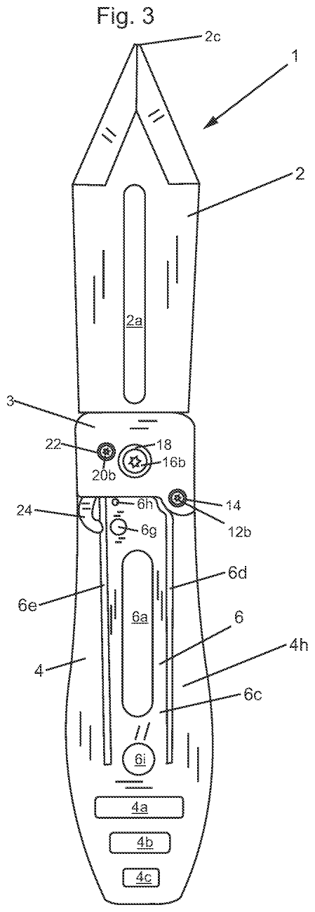

FIG. 3 shows a bottom view of the folding knife apparatus 1 of FIG. 1, with the folding knife apparatus 1 of FIG. 1, shown in the open first state.

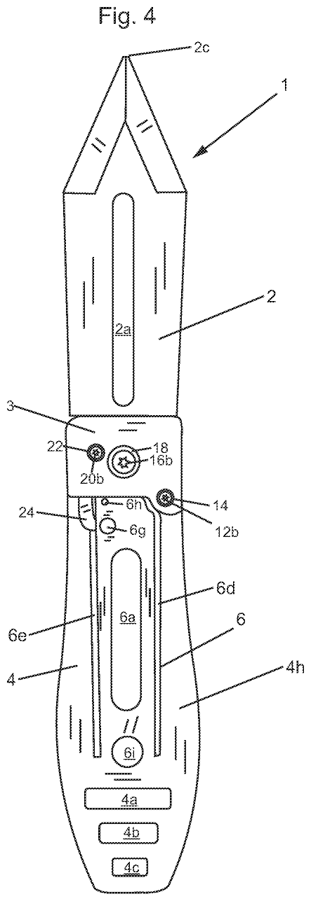

FIG. 4 shows a bottom view of the folding knife apparatus 1 of FIG. 1, with the folding knife apparatus 1 of FIG. 1, shown in the open second state.

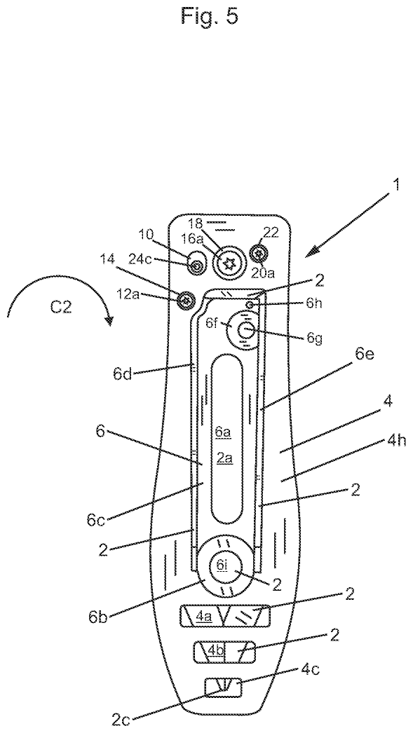

FIG. 5 shows a top view of the folding knife apparatus 1 of FIG. 1, with the folding knife apparatus 1 of FIG. 1, shown in a closed third state.

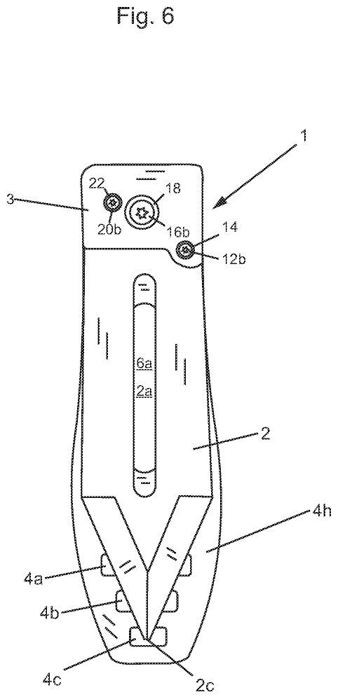

FIG. 6 shows a bottom view of the folding knife apparatus 1 of FIG. 1, with the folding knife apparatus 1 of FIG. 1, shown in the closed third state.

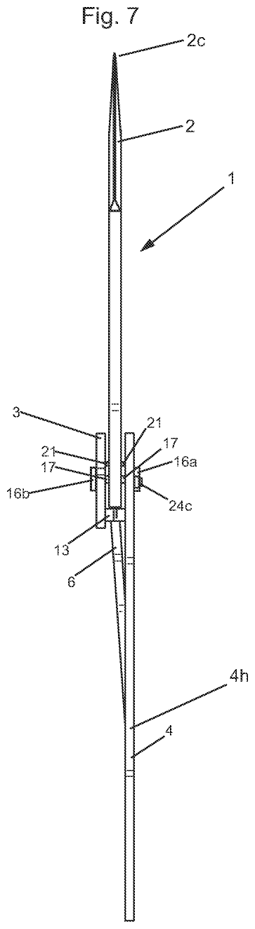

FIG. 7 shows a left side view of the folding knife apparatus 1 of FIG. 1, with the folding knife apparatus 1 of FIG. 1, shown in the open first state.

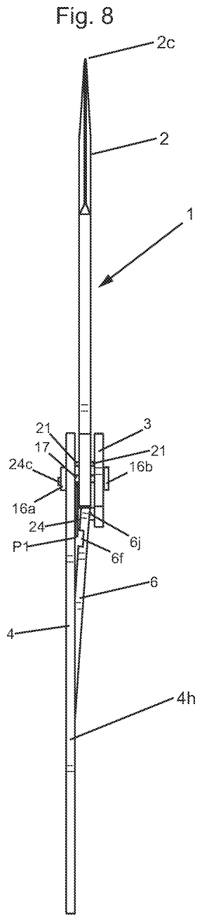

FIG. 8 shows a right side view of the folding knife apparatus 1 of FIG. 1, with the folding knife apparatus 1 of FIG. 1, shown in the open first state.

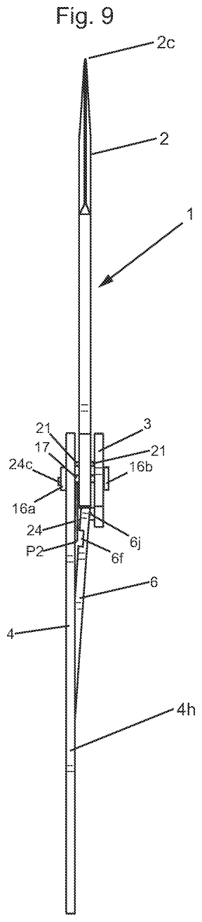

FIG. 9 shows a right side view of the folding knife apparatus 1 of FIG. 1, with the folding knife apparatus 1 of FIG. 1, shown in the open second state.

Referring to FIGS. 1-9, the folding knife apparatus 1 includes a blade portion 2, and a handle portion 4 shown in FIG. 1. The folding knife apparatus 1 further includes a connecting piece 3 shown in FIG. 3.

The handle portion 4 may include a flexing plate 6. The flexing plate 6 may have an elongated slot 6a. There are elongated openings tracks or slots 6e and 6d between the flexing plate 6 and the rest of handle portion 4. There is a circular opening 6i near a bottom of the flexing plate 6 where it connects to the rest of handle portion 4. There are openings or slots 4a, 4b, and 4c in the handle portion 4. The handle portion 4 may include a base portion 4h, which may be the part of the handle portion 4 not including the flexing plate 6.

The flexing plate 6 is biased with respect to the base portion 4h, so that the flexing plate 6 is normally at least partially misaligned with respect to the base portion 4h as shown, for example, in FIGS. 7-9. The flexing plate 6 typically needs to be forced downwards towards the base portion 4h in order to change the folding knife apparatus 1 from an open state, such as shown in FIG. 1 to a closed state, such as shown in FIG. 5. In the closed state of FIG. 5, the blade portion 2 exerts a force on the flexing plate 6 to hold the flexing plate 6 in alignment or in substantial alignment with respect to the base portion 4h of the handle portion 4. When the blade portion 2 is rotated with respect to the handle portion 4, from the closed state of FIG. 5 back to the open state of FIG. 1, the blade portion 2 is rotated until in the open state the blade portion 2 is no longer exerting a force on the flexing plate 6, and in the open state the flexing plate 6 is misaligned with the base portion 4h as shown in FIGS. 7-9.

The handle portion 4 and the flexing plate 6 may be hard metal plates, such as made of stainless steel. The flexing plate 6 may have a body portion 6c, an opening 6g, and a protrusion or pin 6h. The blade portion 2 includes a tip 2c and an elongated slot 2a.

The connecting piece 3 has circular openings 22, 18, and 14 as shown in FIG. 3. Screws, caps, or nuts 20b, 16b, and 12b fit in circular openings 22, 18, and 14, respectively, as shown in FIG. 3.

There is a hook shaped or J-shaped piece 24 shown in FIG. 3, which can be moved by moving a button 24c in a slot 10, as shown by FIGS. 1-4. When the button 24c is slid into a downward position in the slot 10, as shown in FIG. 1, the J-shaped piece 24 is in a position and orientation as shown in FIG. 3, such that the flexing plate 6 can be flexed from out of alignment with the rest of handle portion 4 to into alignment with the rest of handle portion 4. When the button 24c is slid into an upwards position in the slot 10, as shown in FIG. 2, the J-shaped piece 24 is rotated into a position and orientation as shown in FIG. 4, such that the flexing plate 6 cannot be flexed from out of alignment with the rest of the handle portion 4. Since the flexing plate 6 cannot be flexed from out of alignment with the rest of the handle portion 4, as shown in FIG. 9, the blade portion 2 cannot be folded with respect to the handle portion 4, and the blade portion 2 remains in the open state of FIG. 2 and FIG. 4.

The connecting piece 3 is fixed to the handle portion or plate 4 by screws, nuts, or bolts, 20b (shown in FIG. 4) and 20a (shown in FIG. 2), 12b (shown in FIG. 4) and 12a (shown in FIG. 2), and 16b (shown in FIG. 4), and 16a (shown in FIG. 2). The screws, nuts, or bolts 20b and 20a are connected together through a pin 21 shown in FIG. 7. The screws, nuts, or bolts 12b and 12a are connected together through pin 13, shown in FIG. 7. The screws, nuts, or bolts 16b and 16a are connected together through a pin 17.

The blade portion 2 is rotatably mounted through screws, nuts, or bolts 16b, 16a, and through pin 17 (shown in FIGS. 7-9) to the handle portion 4 so that the blade portion 2 can rotate with respect to the handle portion 4, when the J-shaped piece 24 is in the state shown in FIG. 3.

The protrusion or pin 6h, which is integrated with the flexing plate 6, aligns with an opening or indentation at the bottom of the blade portion 2, when the folding knife apparatus 1 is in the closed state shown in FIG. 5.

The pin 13, shown in FIG. 7 functions as a stop to prevent the blade portion 2 from rotating in a counterclockwise direction C1, with respect to handle portion 4, beyond the fully open orientation shown in FIG. 1. The pin 13, shown in FIG. 7, also functions as a stop to prevent the blade portion 2 from rotating in a clockwise direction C2, with respect to handle portion 4, beyond the fully closed orientation shown in FIG. 5.

All components of the folding knife apparatus 1 may be made of metal.

The J-shaped piece or portion 24, in at least one embodiment, is a further mechanism, along with the flexing piece 6, to keep the folding knife apparatus 1 in a fully open state as in FIG. 1, along with the flexing plate or piece 6. The flexing piece 6, when out of alignment with the rest of the handle portion 4, meshes, contacts, and or abuts a bottom of the blade portion 2, which does not allow the blade portion 2 to be rotated out of the open position of FIG. 1, into a closed position, such as in FIG. 6.

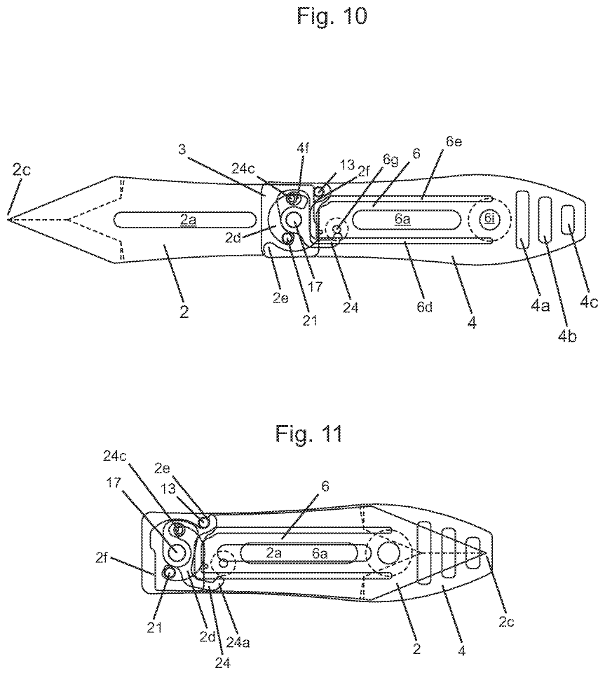

FIG. 10 shows a bottom view of the folding knife apparatus 1 of FIG. 1, with the folding knife apparatus 1 of FIG. 1, shown in the open second state as in FIG. 4, except that FIG. 10, unlike FIG. 4, is a transparent and/or wireframe view, which shows inner components, and shows inner pins, 13, 17, and 21 but not outer caps or nuts, 12a-b, 16a-b, and 20a-b, which are shown in the combination of FIGS. 1 and 3.

FIG. 10 shows an arcuate slot 2d in the blade portion 2. Blade portion 2 also includes a notch 2e and a flat surface or edge 2f.

FIG. 11 shows a top view of the folding knife apparatus 1 of FIG. 1, with the folding knife apparatus 1 of FIG. 1, shown in a closed third state, as in FIG. 5, except that FIG. 11, unlike FIG. 5, is a transparent and/or wireframe view, which shows inner components, and shows inner pins 13, 17, 21 but not outer caps or nuts, 12a-b, 16a-b, and 20a-b, which are shown in the combination of FIGS. 1 and 3.

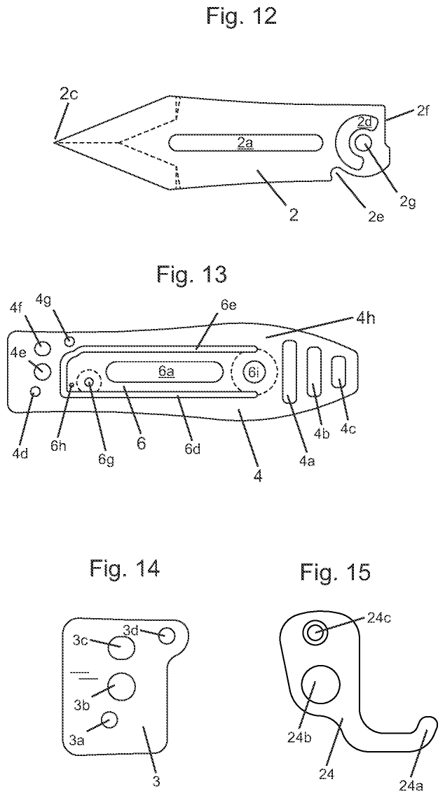

FIG. 12 shows the blade plate or blade portion 2 of the folding knife apparatus 1 of FIG. 1. As shown in FIG. 12, the blade portion 2 includes slot 2a, tip 2c, arcuate slot 2d, notch 2e, opening 2g, and flat edge or surface 2f.

FIG. 13 shows the handle plate or handle portion 4 of the folding knife apparatus 1 of FIG. 1. The handle portion 4 includes a flexing plate portion 6. The flexing plate portion has a slot 6a. There are slots or gaps 6e and 6d which separate flexing plate portion 6 the rest of handle plate portion 4. There is an opening 6g in the flexing plate 6 and an opening 6i at the junction of flexing plate 6 and the rest of handle plate portion 4. The flexing plate 6 also has a protruding pin 6h.

The handle portion 4 further includes openings 4d, 4e, 4f, and 4g.

FIG. 14 shows the connecting plate 3 of the folding knife apparatus 1 of FIG. 1. The connecting plate 3 has openings 3a, 3b, 3c, and 3d.

FIG. 15 shows a rotating piece 24 of the folding knife apparatus 1 of FIG. 1. The rotating piece 24 has a J-shaped or hook shaped protrusion 24a, an opening 24b, and pin 24c.

To assemble the pieces shown in FIGS. 12-15, the connecting piece 3 can be laid on a flat surface, and then the blade portion 2 can be laid on top of the connecting piece 3, so that opening 2g of the blade portion aligns with opening 3b of the connecting piece 3. Next the rotating piece 24 can be laid on top of the blade portion so that opening 24b of the rotating piece aligns with opening 3b of the connecting piece 3 and opening 2g of the blade portion 2. Next the handle portion 4 can be laid on top of the connecting piece 3 so that opening 4e aligns with the openings 24b, 2g, and 3b; the opening 4g aligns with the opening 3d; the openings 4d and 4f align with the openings 3a and 3c respectively; and the protrusion or pin 24c is inserted through the slot or opening 4f, as shown in FIG. 10.

With the components 3, 2, 24, and 4, arranged in this sandwich manner, pin 17 can be inserted through the aligned central openings 3b, 2g, 24b, and 4e (together which may be called central opening 18), and then caps, nuts or screws 16a and 16b, can be screwed on both ends of pin 17 to hold the components 3, 2, 24, and 4 together. In addition, pin 21 can be inserted through the aligned openings 3a and 4d (also called opening 22) and then caps or nuts 20a and 20b can be screwed on both ends of pin 21 to hold connecting piece 3 and handle portion 4 together. In addition, pin 13 can be inserted through the aligned openings 3d and 4g (also called opening 14) and then caps or nuts 12a and 12b can be screwed onto opposing ends of pin 13 to further hold connecting piece 3 and handle portion 4 together.

As shown in FIG. 10, the edge or surface 2f, along with the pin 13, are used as a stop (by edge 2f contacting pin 13) to prevent the blade portion 2 from over rotating from the fully opened position of FIG. 10, so that the blade portion 2 is aligned with the handle portion 4 in the state of FIG. 10.

As shown in FIG. 11, the notch 2e, along with the pin 13, are used as a stop (by pin 13 contacting notch 2e) to prevent the blade portion 2 from over rotating from the fully closed position of FIG. 11, so that the blade portion 2 overlaps the handle portion 4 in the state of FIG. 10.

The rotating piece 24 rotates about pin 17 as limited by the pin 24c limited movement in the slot 4f or slot 10 shown in FIG. 1.

The blade portion 2 has an indentation, not shown, on a side opposite the side shown in FIG. 12, and the pin 6h fits snugly into the indentation of the blade portion 2 when the folding knife apparatus is in the closed state shown in FIG. 11.

Although the invention has been described by reference to particular illustrative embodiments thereof, many changes and modifications of the invention may become apparent to those skilled in the art without departing from the spirit and scope of the invention. It is therefore intended to include within this patent all such changes and modifications as may reasonably and properly be included within the scope of the present invention's contribution to the art.

1. A folding knife apparatus comprising:
a blade portion;
a handle portion including a flexing plate connected to a base portion; and
a piece;
wherein the blade portion is connected to the handle portion by a pin so that the blade portion can rotate with respect to the handle portion about the pin when the flexing plate of the handle portion is in alignment with the base portion of the handle portion;
wherein the piece is configured to be placed in a state wherein part of the piece is between part of the flexing plate of the handle portion and the base portion of the handle portion and thereby prevents the flexing plate of the handle portion from moving into alignment with the base portion of the handle portion, and thereby prevents the blade portion from rotating with respect to the handle portion;
wherein the piece is connected to the handle portion and the blade portion by the pin so that the piece is configured to rotate with respect to the handle portion and the blade portion about the pin; and
and wherein at least part of the piece is between the blade portion and the base portion of the handle portion.

2. The folding knife apparatus of claim 1 wherein
the piece has a J-shaped portion, at least a part of which is inserted between the flexing plate and the base portion of the handle portion to prevent the flexing plate of the handle portion from moving into alignment with the base portion of the handle portion.

3. The folding knife apparatus of claim 1 wherein
the flexing plate has a slot into which the piece is at least partially inserted to prevent the flexing plate of the handle portion from moving into alignment with the base portion of the handle portion.

4. The folding knife apparatus of claim 2 wherein
the flexing plate has a slot into which the piece is at least partially inserted to prevent the flexing plate of the handle portion from moving into alignment with the base portion of the handle portion.

5. The folding knife apparatus of claim 1 wherein
the piece is connected to a protrusion which protrudes out through an opening in the base portion of the handle portion;
wherein the protrusion can be moved to cause the piece to be rotated with respect to the base portion of the handle portion and with respect to the blade portion into either a state where the piece prevents the flexing plate of the handle portion from moving into alignment with the base portion of the handle portion or a state where the piece does not prevent the flexing plate of the handle portion from moving into alignment with the base portion of the handle portion.

6. The folding knife apparatus of claim 2 wherein
the piece is connected to a protrusion which protrudes out through an opening in the base portion of the handle portion;
wherein the protrusion can be moved to cause the piece to be rotated with respect to the base portion of the handle portion and with respect to the blade portion into either a state where the piece prevents the flexing plate of the handle portion from moving into alignment with the base portion of the handle portion or a state where the piece does not prevent the flexing plate of the handle portion from moving into alignment with the base portion of the handle portion.

7. The folding knife apparatus of claim 3 wherein
the piece is connected to a protrusion which protrudes out through an opening in the base portion of the handle portion;
wherein the protrusion can be moved to cause the piece to be rotated with respect to the base portion of the handle portion and with respect to the blade portion into either a state where the piece prevents the flexing plate of the handle portion from moving into alignment with the base portion of the handle portion or a state where the piece does not prevent the flexing plate of the handle portion from moving into alignment with the base portion of the handle portion.

8. The folding knife apparatus of claim 4 wherein
the piece is connected to a protrusion which protrudes out through an opening in the base portion of the handle portion;
wherein the protrusion can be moved to cause the piece to be rotated with respect to the base portion of the handle portion and with respect to the blade portion into either a state where the piece prevents the flexing plate of the handle portion from moving into alignment with the base portion of the handle portion or a state where the piece does not prevent the flexing plate of the handle portion from moving into alignment with the base portion of the handle portion.

9. A method comprising:
connecting a piece, base portion of a handle portion, and a blade portion to form a folding knife apparatus by use of a pin so that the piece is configured to rotate with respect to the handle portion and the blade portion about the pin; so that at least part of the piece is between the blade portion and the base portion of the handle portion; and so that the blade portion can rotate with respect to the handle portion when a flexing plate of the handle portion is in alignment with the base portion of the handle portion; and
rotating the piece with respect to the base portion of the handle portion and with respect to the blade portion into in a state wherein part of the piece is between part of the flexing plate of the handle portion and the base portion of the handle portion and thereby prevents the flexing plate of the handle portion from moving into alignment with the base portion of the handle portion, and thereby prevents the blade portion from rotating with respect to the handle portion.

10. The method of claim 9 wherein
rotating the piece includes rotating a J-shaped portion of the piece, so that at least part of the J-shape portion is inserted between the flexing plate and the base portion of the handle portion to prevent the flexing plate of the handle portion from moving into alignment with the base portion of the handle portion.

11. The method of claim 9 wherein
rotating the piece includes inserting at least part of the piece into a slot of the flexing plate to prevent the flexing plate of the handle portion from moving into alignment with the base portion of the handle portion.

12. The method of claim 10 wherein
rotating the piece includes inserting at least part of the piece into a slot of the flexing plate to prevent the flexing plate of the handle portion from moving into alignment with the base portion of the handle portion.

13. The method of claim 9 wherein
the piece is connected to a protrusion which protrudes out through an opening in the base portion of the handle portion; and further comprising:
moving the protrusion to cause the piece to be rotated into either a state where the piece prevents the flexing plate of the handle portion from moving into alignment with the base portion of the handle portion or a state where the piece does not prevent the flexing plate of the handle portion from moving into alignment with the base portion of the handle portion.

14. The method of claim 10 wherein
the piece is connected to a protrusion which protrudes out through an opening in the base portion of the handle portion; and further comprising:
moving the protrusion to cause the piece to be rotated into either a state where the piece prevents the flexing plate of the handle portion from moving into alignment with the base portion of the handle portion or a state where the piece does not prevent the flexing plate of the handle portion from moving into alignment with the base portion of the handle portion.

15. The method of claim 11 wherein
the piece is connected to a protrusion which protrudes out through an opening in the base portion of the handle portion; and further comprising:
moving the protrusion to cause the piece to be rotated into either a state where the piece prevents the flexing plate of the handle portion from moving into alignment with the base portion of the handle portion or a state where the piece does not prevent the flexing plate of the handle portion from moving into alignment with the base portion of the handle portion.

16. The method of claim 12 wherein
the piece is connected to a protrusion which protrudes out through an opening in the base portion of the handle portion; and further comprising:
moving the protrusion to cause the piece to be rotated into either a state where the piece prevents the flexing plate of the handle portion from moving into alignment with the base portion of the handle portion or a state where the piece does not prevent the flexing plate of the handle portion from moving into alignment with the base portion of the handle portion.
